(19) United States
(12) Patent Application Publication
(10) Pub. No.: US 2026/0330030 A1
(43) Pub. Date: Oct. 22, 2026

(54) STORAGE DEVICE AND STORAGE DEVICE COUNTING METHOD

(71) Applicant: MACRONIX INTERNATIONAL CO., LTD., HSINCHU (TW)

(72) Inventors: Chia-Jung CHEN, Zhubei City (TW); Chin-Hung CHANG, Tainan (TW); Ken-Hui CHEN, Hsinchu City (TW); Chun-Hsiung HUNG, Hsinchu City (TW)

(21) Appl. No.: 19/181,410

(22) Filed: Apr. 17, 2025

(51) Int. Cl. G06F 21/60; G06F 21/64; G06F 21/79

(52) U.S. Cl. CPC G06F 21/602; G06F 21/64; G06F 21/79

(57) ABSTRACT

A storage device includes a counting circuit, a non-volatile memory and a conversion circuit. The counting circuit is configured to generate a count value. The non-volatile memory is coupled to the counting circuit and is configured to store the count value. The conversion circuit is coupled to the non-volatile memory and is configured to convert the count value into a non-linear value according to a conversion relationship. The conversion relationship is not an increment or decrement relationship, and when the count value corresponds to a plurality of different values, the non-linear value generated by the conversion circuit does not be repeated.

### BACKGROUND

### Technical Field

The present disclosure relates to data storage and transmission technology, and more particularly to a storage device and a storage device counting method.

### Description of Related Art

With the advancement of computational performance and storage technology, the demands for the performance of storage devices have also increased. In response to market demands, improving the applications of memory to not only enable data reading and writing but also incorporate security mechanisms to prevent information leakage has become a critical challenge.

### SUMMARY

One aspect of the present disclosure is a storage device, comprising a counting circuit, a non-volatile memory and a conversion circuit. The counting circuit is configured to generate a count value. The non-volatile memory is coupled to the counting circuit and is configured to store the count value. The conversion circuit is coupled to the non-volatile memory and is configured to convert the count value into a non-linear value according to a conversion relationship. The conversion relationship is not an increment relationship or a decrement relationship. When the count value corresponds to a plurality of different values, the non-linear value generated by the conversion circuit does not be repeated.

Another aspect of the present disclosure is a storage device counting method, comprising: generating, by a counting circuit, a count value; and converting, by a conversion circuit, the count value into a non-linear value according to a conversion relationship, wherein the conversion relationship is not an increment relationship or a decrement relationship, and when the count value corresponds to a plurality of different values, the non-linear value generated by the conversion circuit does not be repeated.

Another aspect of the present disclosure is a storage device, comprising a non-volatile memory, a control circuit and a conversion circuit. The non-volatile memory is configured to store a count value and a storage data. The control circuit is configured to change the count value when transmitting the storage data. The conversion circuit is coupled to the non-volatile memory, and is configured to convert the count value into a non-linear value. The count value and the non-linear value do not have an increment relationship or a decrement relationship between both.

It is to be understood that both the foregoing general description and the following detailed description are by examples, and are intended to provide further explanation of the disclosure as claimed.

### BRIEF DESCRIPTION OF THE DRAWINGS

The present disclosure can be more fully understood by reading the following detailed description of the embodiment, with reference made to the accompanying drawings as follows:

FIG. 1 is a schematic diagram of a storage device in some embodiments of the present disclosure.

FIG. 2 is a flowchart illustrating a storage device counting method in some embodiments of the present disclosure.

FIG. 3 is a schematic diagram of the count value and the non-linear value in some embodiments of the present disclosure.

### DETAILED DESCRIPTION

For the embodiment below is described in detail with the accompanying drawings, embodiments are not provided to limit the scope of the present disclosure. Moreover, the operation of the described structure is not for limiting the order of implementation. Any device with equivalent functions that is produced from a structure formed by a recombination of elements is all covered by the scope of the present disclosure. Drawings are for the purpose of illustration only, and not plotted in accordance with the original size.

It will be understood that when an element is referred to as being “connected to” or “coupled to”, it can be directly connected or coupled to the other element or intervening elements may be present. In contrast, when an element to another element is referred to as being “directly connected” or “directly coupled,” there are no intervening elements present. As used herein, the term “and/or” includes associated listed items or any and all combinations of more.

The present disclosure relates to a storage device and a storage device counting method. The storage device can be of many types, such as Flash memory, Resistive random-access memory (ReRAM), Electrically-Erasable Programmable Read-Only Memory (EEPROM) or Phase-change memory (PCM). The storage device is used to store digital data and can be easily read or transmitted.

During the transmission of digital data, there may be security issues, such as being captured by hackers (e.g., replay attack), so the storage device must have a security mechanism. One method of security mechanism is to encrypt or verify digital data through Secure Hash Algorithm (SHA) or Hash-based Message Authentication Code (HMAC), and/or verify data with MAC address. In addition, when transmitting data, the processor of the storage device can count and add a count value to the transmitted encrypted signal as part of the encrypted signal, so as to increase the complexity of the encryption.

However, since the count value increases (increment) with the number of transmissions, the count value is still possible to be predicted or cracked. The storage device and the storage device counting method provided by the present disclosure improve the security mechanism of the storage device. In the following paragraphs, “storage device/memory” can be implemented by non-volatile memory such as Flash, ReRAM, EEPROM, PCM, but the present disclosure is not limited to this.

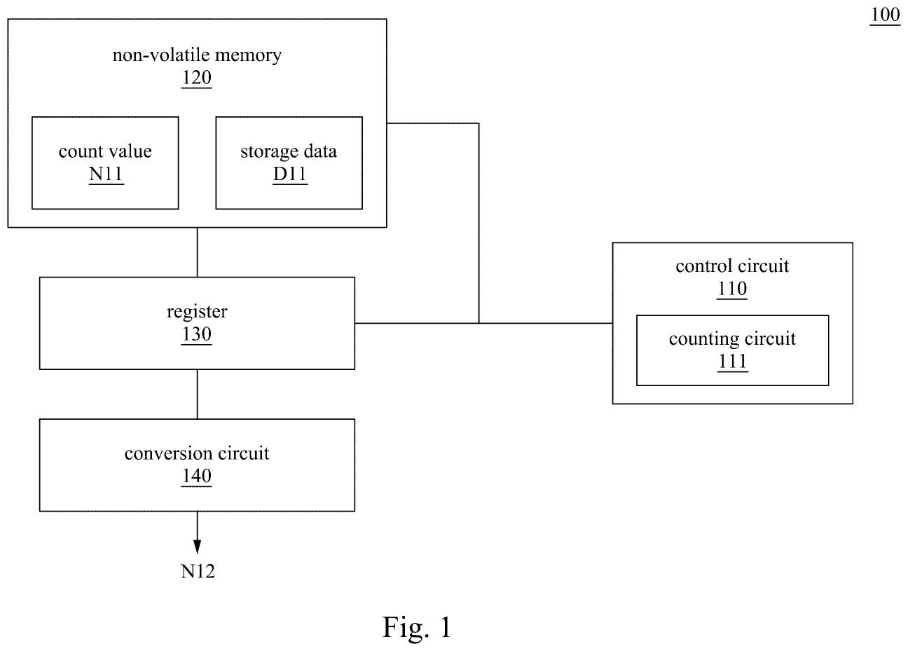

FIG. 1 is a schematic diagram of a storage device 100 in some embodiments of the present disclosure. The storage device 100 includes a control circuit 110, a non-volatile memory 120 a register 130 and a conversion circuit 140. The control circuit 110 includes a counting circuit 111 (e.g., a counter). When the storage device 100 transmits data to the external device every time, the control circuit 110 generates/changes the count value in an increment or decrement manner. For example, during the first data transmission, the count value is “1”, and during the second data transmission, the count value is changed to “2”. In some embodiments, the control circuit 110 can establish a communication connection with the external device through a connection circuit or a communication circuit. Since those skilled in the art can understand the transmission data between different devices, it will not be further described here.

The non-volatile memory 120 is couple to the control circuit 110, and is configured to store a storage data D11, and store the count value N11 generated by the control circuit 110 (the counting circuit 111). In some embodiments, the register 130 is also coupled to the control circuit 110, and is configured to temporarily stores the storage data D11 and the count value N1 to be transmitted.

The above “storage data D11” generally refers to one or more data or files stored in the storage device 100. During data transmission, the storage device 100 may only transmit at least a portion of the storage data D11 to the external device. In other words, the data content of each data transmission may be different. The subsequent paragraphs will use “transmitting the storage data D11” to uniformly refer to the data transmission between the storage device 100 and the external device.

The conversion circuit 140 is coupled to the non-volatile memory 120 through the register 130 (can also be coupled to the control circuit 110), and is configured to convert the count value N11 into a non-linear value N12 according to a conversion relationship. The “conversion relationship” can be a set encoding format, encryption method, scrambling function or mapping table.

The “conversion relationship” and the counting method of the count value N11 generated the counting circuit 111 are different. The conversion relationship is not an increment relationship or a decrement relationship. In other words, the count value N11 and the converted result (the non-linear value N12) do not have an increment relationship or a decrement relationship between both. The “increment or decrement relationship” refers to the corresponding relationship interpreted/identified in decimal format, binary format, or hexadecimal format.

In addition, the “conversion relationship” is irregular and unique. That is, when the count value corresponds to multiple different values, the non-linear value N12 generated by the conversion circuit 140 does not be repeated. For example, if the counting sequence of the count value N11 is “1, 2, 3, 4” (interpreted in decimal), the non-linear value N12 can be four different values such as “3, 1, 2, 6”. The conversion relationship is a preset conversion method with a specific logical relationship. Therefore, for a third party (e.g., hacker) who does not know the conversion relationship, the change of the non-linear value N12 will be irregular.

Accordingly, by converting the count value into an irregular non-linear value, the count value can be complicated, increasing the difficulty for hackers to predict or crack it, thereby improving the security of the storage device.

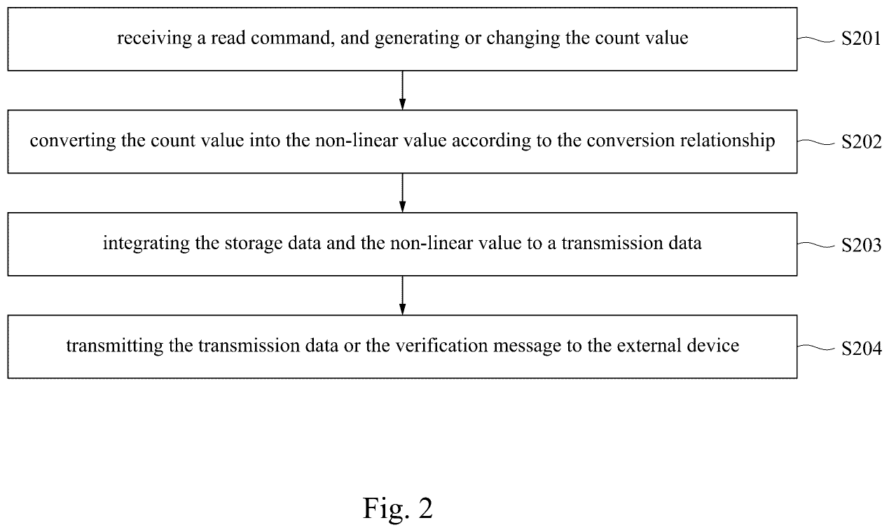

FIG. 2 is a flowchart illustrating a storage device counting method in some embodiments of the present disclosure. In step S201, when the control circuit 110 receives a read command corresponding to the storage data D11, the control circuit 110 generates the count value N11 by the counting circuit 111, and the counting circuit 111 changes the count value N11 by incrementing or decrementing.

In step S202, the conversion circuit 140 converts the count value N11 into the non-linear value according to the conversion relationship. As mentioned above, the conversion relationship and the counting method of the counting circuit 111 are different, and the conversion relationship is not an increment relationship or a decrement relationship. The conversion relationship is a coding format, encryption method, scrambling function or mapping table preset in the conversion circuit 140.

In one embodiment, the conversion relationship includes a cyclic encoding format. The conversion circuit 140 converts the count value N11 from the binary format to the cyclic encoding format to generate the non-linear value N12. The cyclic encoding format can be Gray Code. Gray Code is a cyclic binary unit distance code, and it is defined as: for any two adjacent values, the two corresponding Gray codes differ by only one bit. For example, for the decimal values “0, 1, 2, 3,” the binary codes are “000, 001, 010, 011,” and the Gray codes are “000, 001, 011, 010.” If the Gray code is interpreted as binary, the resulting counting sequence is not incrementing or decrementing, but irregular.

In some embodiments, the conversion relationship can be a scramble function or a mapping table preset in the conversion circuit 140, so that the conversion circuit 140 can convert the count value N11 into the non-linear value N12 accordingly.

In step S203, the control circuit 110 integrates the storage data D11 and the non-linear value N12 to a transmission data. In one embodiment, the control circuit 110 encrypts the transmission data into a verification message according to at least one one-way function, such as encrypting by Hash-based Message Authentication Code (HMAC, HMAC-SHA256).

In step S204, the storage device 100 transmits the transmission data (or the encrypted verification message) to the external device through an output buffer circuit (not shown in figure). With the corresponding non linear value complexity, external devices can more confidentially obtain the integrity of storage data D11 and also prevent replay attacks.

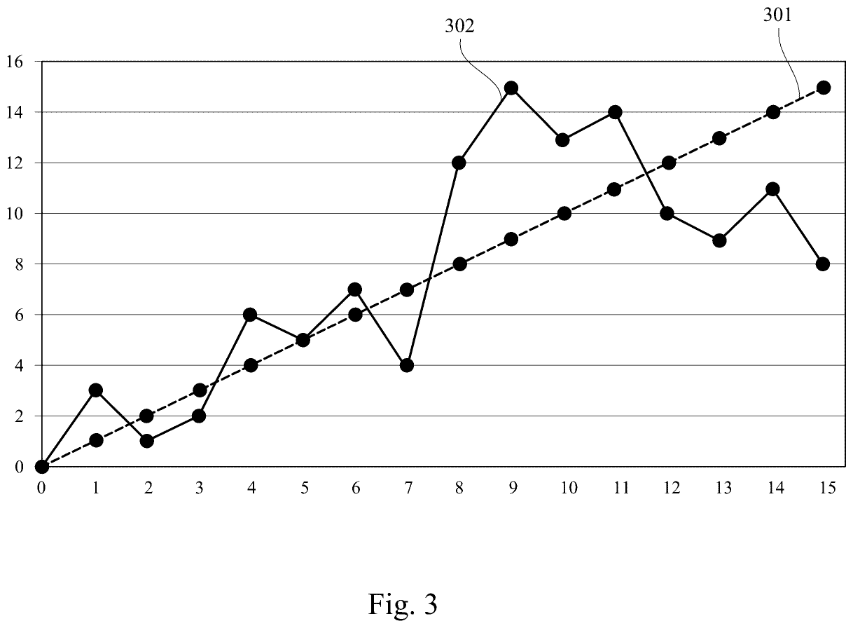

FIG. 3 is a schematic diagram of the count value N11 and the non-linear value N12 in some embodiments of the present disclosure. In this embodiment, the counting circuit 111 counts/records the count value N11 by an increment method, and the conversion circuit 140 generates the non-linear value N12 according to a mapping table.

In FIG. 3, the vertical axis represents values interpreted in decimal, and the horizontal axis represents numbers of data transmission. The trace 301 is the counting sequence of the count value N11, and the trace 302 is the counting sequence of the non-linear value N12. As shown in FIG. 3, the counting sequence of the count value N11 is “0, 1, 2, 3, 4”, and the counting sequence of the non-linear value N12 is “0, 3, 1, 2”. If the non-linear value N12 is interpreted in binary format, the result will be irregular, so security of the storage device can be improved.

The elements, method steps, or technical features in the foregoing embodiments may be combined with each other, and are not limited to the order of the specification description or the order of the drawings in the present disclosure.

It will be apparent to those skilled in the art that various modifications and variations can be made to the structure of the present disclosure without departing from the scope or spirit of the present disclosure. In view of the foregoing, it is intended that the present disclosure cover modifications and variations of this present disclosure provided they fall within the scope of the following claims.

What is claimed is:

1. A storage device, comprising:
a counting circuit configured to generate a count value;
a non-volatile memory coupled to the counting circuit and configured to store the count value; and
a conversion circuit coupled to the non-volatile memory and configured to convert the count value into a non-linear value according to a conversion relationship, wherein the conversion relationship is not an increment relationship or a decrement relationship, and when the count value corresponds to a plurality of different values, the non-linear value generated by the conversion circuit does not be repeated.

2. The storage device of claim 1, further comprising:
a control circuit comprising the counting circuit, wherein the control circuit is configured to integrate the non-linear value and a storage data into a transmission data, and transmit the transmission data to an external device.

3. The storage device of claim 2, wherein the control circuit is further configured to encrypt the transmission data into a verification message according to at least one one-way function, so as to transmit the verification message to the external device.

4. The storage device of claim 1, wherein the conversion circuit is configured to convert the count value from a binary format to a cyclic encoding format to generate the non-linear value.

5. The storage device of claim 4, wherein the cyclic encoding format is Gray code.

6. The storage device of claim 1, wherein the conversion circuit is configured to convert the count value into the non-linear value according to a scramble function.

7. The storage device of claim 1, wherein the conversion circuit is configured to convert the count value into the non-linear value according to a mapping table.

8. A storage device counting method, comprising:
generating, by a counting circuit, a count value; and
converting, by a conversion circuit, the count value into a non-linear value according to a conversion relationship, wherein the conversion relationship is not an increment relationship or a decrement relationship, and when the count value corresponds to a plurality of different values, the non-linear value generated by the conversion circuit does not be repeated.

9. The storage device counting method of claim 8, further comprising:
integrating, by a control circuit, the non-linear value and a storage data into a transmission data, so as to transmit the transmission data to an external device.

10. The storage device counting method of claim 9, further comprising:
encrypting the transmission data into a verification message according to at least one one-way function, so as to transmit the verification message to the external device.

11. The storage device counting method of claim 8, wherein converting the count value into the non-linear value according to the conversion relationship comprises:
converting the count value from a binary format to a cyclic encoding format to generate the non-linear value.

12. The storage device counting method of claim 11, wherein the cyclic encoding format is Gray code.

13. The storage device counting method of claim 8, wherein converting the count value into the non-linear value according to the conversion relationship comprises:
converting the count value into the non-linear value according to a scramble function.

14. The storage device counting method of claim 8, wherein converting the count value into the non-linear value according to the conversion relationship comprises:
converting the count value into the non-linear value according to a mapping table.

15. A storage device, comprising:
a non-volatile memory configured to store a count value and a storage data;
a control circuit configured to change the count value when transmitting the storage data; and
a conversion circuit coupled to the non-volatile memory, and configured to convert the count value into a non-linear value, wherein the count value and the non-linear value do not have an increment relationship or a decrement relationship between both.

16. The storage device of claim 15, wherein the control circuit is configured to integrate the non-linear value and the storage data into a transmission data, and transmit the transmission data to an external device.

17. The storage device of claim 16, wherein the control circuit is configured to encrypt the transmission data into a verification message according to at least one one-way function, so as to transmit the verification message to the external device.

18. The storage device of claim 15, wherein the conversion circuit is configured to convert the count value from a binary format to a cyclic encoding format to generate the non-linear value.

19. The storage device of claim 18, wherein the cyclic encoding format is Gray code.

20. The storage device of claim 15, wherein the conversion circuit is configured to convert the count value into the non-linear value according to a scramble function or a mapping table.
